(19) United States
(12) Patent Application Publication
(10) Pub. No.: US 2005/0015612 A1
(43) Pub. Date: Jan. 20, 2005

(54) Parent-children interactive intelligent management system

(76) Inventors: Jing-Lung You, Taipei (TW); Cheng-Chi Huang, Taipei (TW); Kai-Hsiang Chang, Taipei (TW); Shu-Hui Chen, Taipei (TW)

Correspondence Address: BIRCH STEWART KOLASCH & BIRCH, PO BOX 747, FALLS CHURCH, VA, 22040-0747, US

(21) Appl. No.: 10/617,821

(22) Filed: Jul. 14, 2003

(51) Int. Cl. H04L 9/00

(52) U.S. Cl. 713/200

(57) ABSTRACT

A parent-children interactive intelligent management system for managing computer use authorization, time and operating system functions of users includes a computer device, a reading device and a memory device. When the memory device is inserted into the reading device, the computer device can process data management for data in the memory device and settings. When a child inserts the memory card into the reading device, the child can only use the operating system according to the set conditions in the memory card. Thus computer use time of the child may be restricted to prevent the child from accessing undesirable Web sites. The parent can leave messages and inquire the child about computer use status to enhance the interactive relationship between the parent and the child.

### FIELD OF THE INVENTION

The present invention relates to a parent-children interactive intelligent management system and particularly to a system to manage computer use status of users (children) and enable parents to achieve interactive relationship with children to enhance their affection.

### BACKGROUND OF THE INVENTION

Nowadays the popularity of computer has extended to children. Computer provides unlimited space and learning environments to the E-generation children. However, while they can enjoy great conveniences, they also are tempted to indulge in the computer games or cyber world because of lack of self discipline. Some even are obsessive in adult web sites. It not only affects the physical and rental developments of children, also reduces their chances of participating outdoor activities. Research reports indicate that children who indulge in the cyber world for a prolonged period of time tend to have a lower adaptability to real life that affects their character development. Hence power supply locks for computer have been developed to cutoff the internal circuit of computer and disable the computer to limit computer use time for children. However, such a measure is an overreaction. To completely isolate children from accessing the computer deprives the children a powerful tool and may hinder they intelligent development.

### SUMMARY OF THE INVENTION

Therefore the primary object of the invention is to resolve the aforesaid disadvantages and overcome the drawbacks of the prior art. The invention provides a parent-children interactive intelligent management system that is loaded into a computer. Children may use a card to start and use the computer. Parent can use another card to manage children regard computer use authorization, time and systems. When the authorization cannot meet the actual requirements, the children can ask the parent to change card setting so that the parent and children have interactions and their affection may enhance.

In order to achieve the foregoing object, the parent-children interactive intelligent management system of the invention includes a computer device, a reading device and a memory device. The memory device may be inserted into the reading device. The computer device can process data management and setting for the memory device. When the memory card of the children is inserted into the reading device, the operating system of the computer device can only be used according to the set conditions stored in the memory device. And computer use time, status and browsed web sites of the children may be restricted and inspected. In addition, the parent and children may have interaction through message function to enhance their affection.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a hardware block diagram of the parent-children interactive intelligent management system of the invention.

FIGS. 2A and 2B are flow charts of the invention for program executing system setting.

FIG. 3 is a setting process flow chart of the invention for altering card authorization.

FIGS. 4A and 4B are identification flow charts of the invention for logon the system by card.

FIG. 5 is a use time management flow chart for users of the invention.

### DETAILED DESCRIPTION OF THE PREFERRED EMBODIMENTS

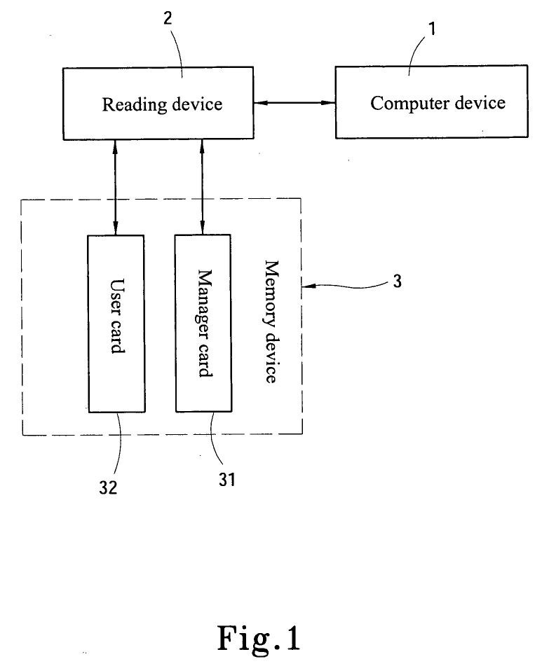

Please refer to FIG. 1, the hardware system of the invention includes a computer device 1, a reading device 2 connecting to the computer device 2 and a memory device 3 insertable into the reading device 2. When the memory device 3 is inserted into the reading device 2, the computer device 1 may process data management in the memory device 3 and perform settings. After children insert the memory card 3 into the reading device 2, the children can only use the operating system of the computer device 1 set by the conditions in the memory card 3. And computer use time of the children also is restricted, and prohibited web sites cannot be accessed by the children. When the setting conditions of the memory card 3 cannot meet requirements, the children can ask the parent to alter the setting of the memory card 3. Therefore the parent and children have interaction and their affection may enhance.

The computer device 1 may be either a desktop computer or a notebook computer. After management software are loaded (will be discussed later), each operating system originally resided in the computer will be configured and updated. The reading device 2 may a general card reader on the market to read data stored in the memory card 3, or store the data of completed settings processed by the computer 1 into the memory device 3 again. The memory device 3 may be a general IC card or a diskette. When the system is in use, the memory device 3 may be set to a manager (parent) card 31 and a user (children) card 32. A plurality of manager cards and user cards may be set, or a plurality of user cards may be managed by a single manager.

When the system is started first, the management software is loaded into the computer device 1 to configure and set various operating systems originally resided in the computer device 1; next, the manager card 31 is inserted into the reading device 2 to communicate with the computer device 1 to perform setting of the manager card 31, meanwhile use authorization, time and functions of each user in the computer device 1 also are set, and messages or inquiries for user's use records or manager's management records also are set. After settings of manager card 31 and operating systems in the computer device 1 have been completed, user card 32 may be inserted into the reading device 2 to perform setting of user's account number, password, authorization, time and functions in the computer device 1. Once a user inserts the user card 32 into the reading device 2, the user can use the internal systems resided in the computer device 1 according to the setting authorization, time and functions recorded in the user card 32. When the user card 32 cannot meet user's requirements, the user may ask the manager to do alteration. Manager can use manager card 31 to enter the computer device 1, and retrieve the user card 32 to reset the authorization, time and functions to meet user's requirements.

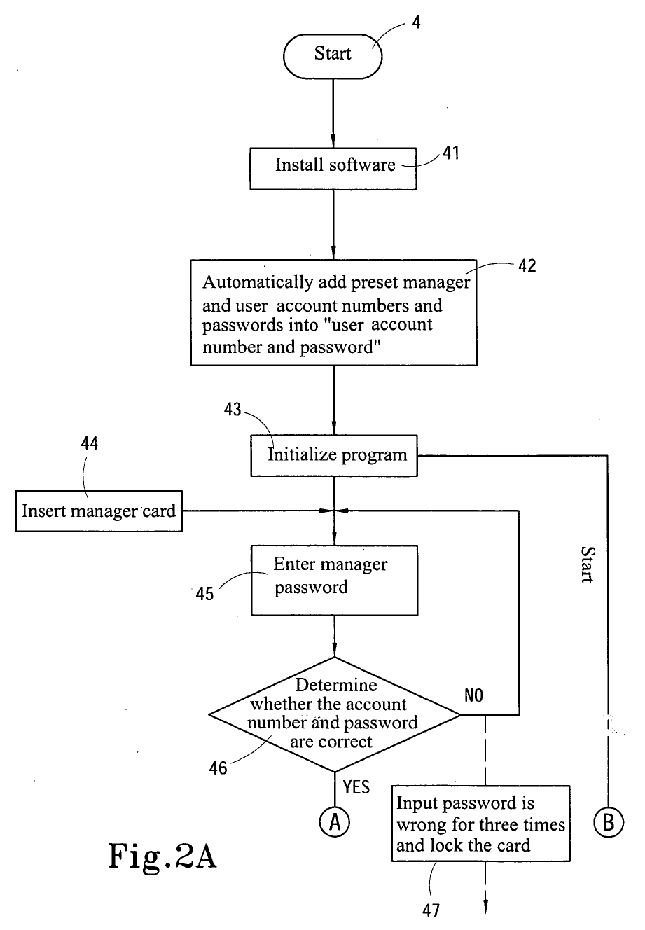

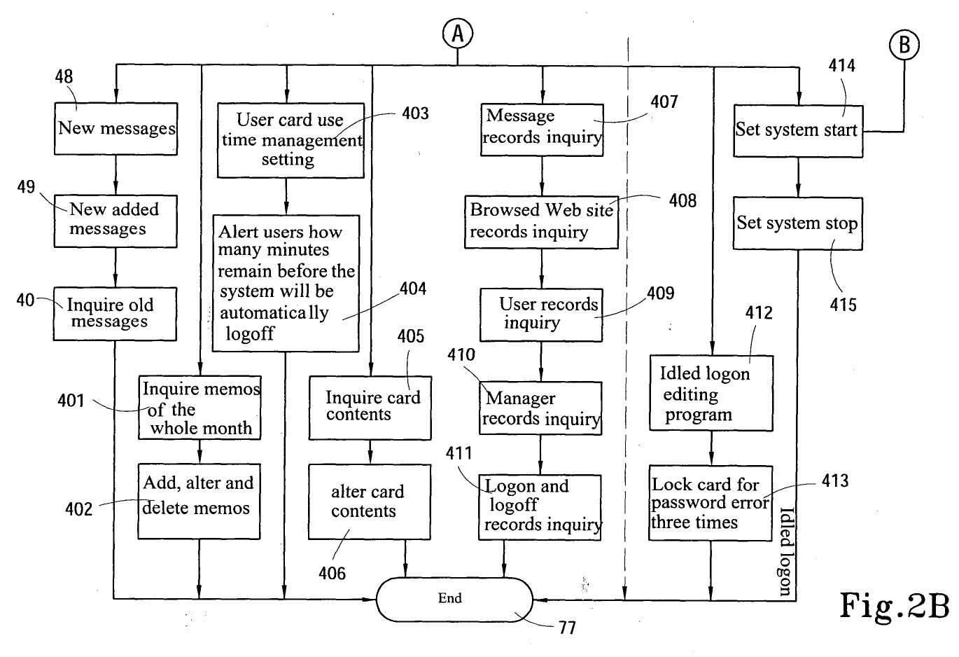

Refer to FIGS. 1, 2A and 2B for the hard ware structure and process flows for program executing system setting of the invention. As shown in the drawings, it begins by start 4; first install software 41, in the process the software automatically adds preset manager and user account numbers and passwords into “user account number and password” of control station 42; then initialize program 43; insert manager card 44, the computer device 1 displays picture for entering manager password 45 (each card insertion will automatically display account number); after the password is input, determine whether the account number and password are correct 46. If the input password is wrong for three times, the card is locked 47 (manager may also set the system not locking card), and the system ends. If the password input by the manager is corrected, enter the parent-children intelligent management system. The manager can perform function setting, card setting, record inquiry, advanced setting and system description, etc. When the manager selects function setting, he/she can perform setting for message, memo and time. Execution of message setting includes reading new message 48, new added message 49 and inquire old message 40. If no other function to be performed, end the system. When setting memo is selected, in includes inquiry of the memos of the whole month 401, and add, alter and delete memos 402. If no other function to be performed, end the system. When setting of time is selected, perform setting 403 of use time management for the user card. The setting may include allowable use frequency every day for the card, use time frame in a week, use duration every time, and alert functions a few minutes prior to time expired, etc. After the settings have been completed, alert users how many minutes remain before the system will be automatically logged off 404; if no other function to be performed, end the system. When card setting is selected, it may include inquiry of card contents 405 and modify card contents 406 to facilitate inquiry and modifying of user card contents; if no other function to be performed, end the system. When record inquiry is selected, it may include message record inquiry 407, inquiry of browsed web site records (to inquire user's access web sites) 408, user record inquiry 409, manager record inquiry 410 and logon and logoff record inquiry 411 (to inquire user's use status), if no other function to be performed, end the system. When advanced setting is selected, it performs security setting and system setting. When the security setting is selected, may set idled logon editing program 412 and lock card setting for password error three times 413, etc., if no other function to be performed, end the system. When system setting is selected, may perform setting system start 414 and setting system stop 415, if no other function to be performed, end the system. After the foregoing functions have been executed, program execution of system setting process is completed.

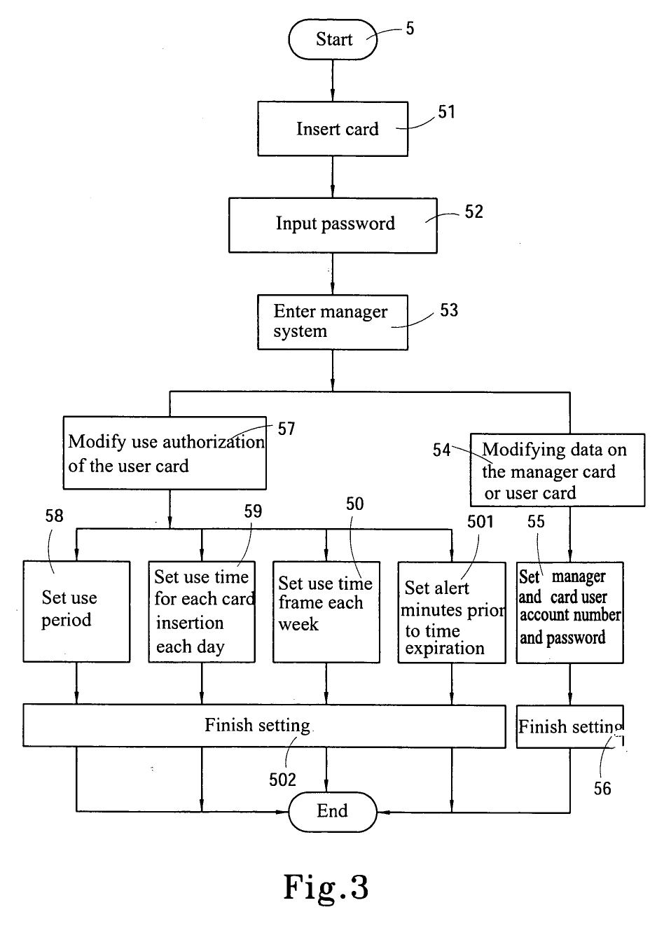

Refer to FIG. 3 for the setting process flow of the invention for altering card authorization. As shown in the drawing, start 5 to alter card authorization insert card 51; enter password (with a preset value for the IC card when use at the first time) 52; enter manager system 53, if the card being inserted into the reading device is a manager card or user card, proceed modifying data on the manager card or user card 54, setting manager or card user's account number and password 55, and finishing settings for the manager card or user card 56. If the inserted card is a manager card, it may modify use authorization of the user card 57, set use period 58, set use time of each card insertion each day 59, set use time frame each week 50, and set alert minutes prior to time expired 501, etc. After all the foregoing settings are finished 502, setting process of user card data is completed.

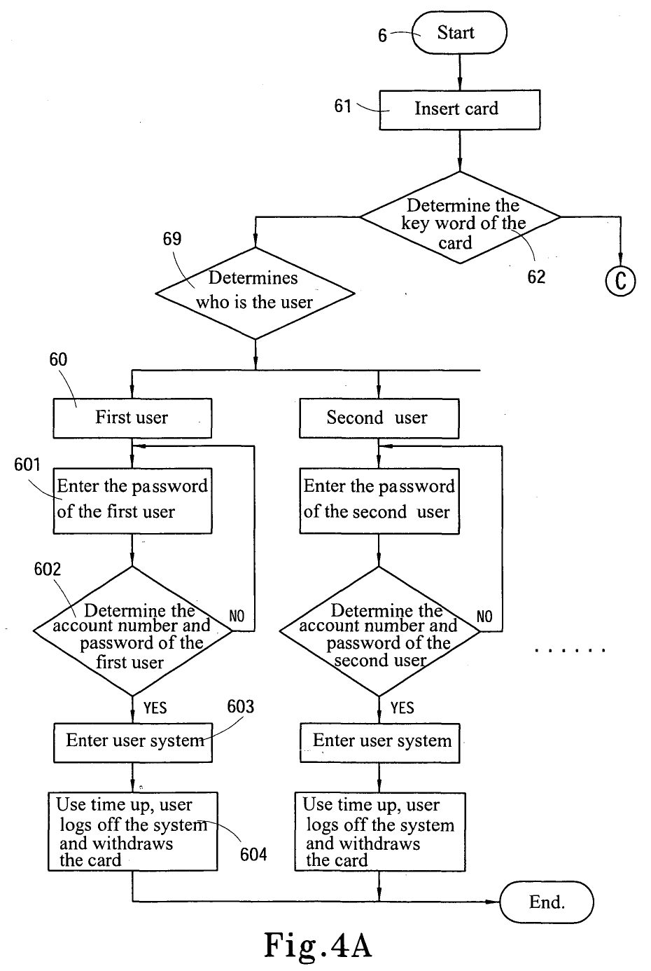

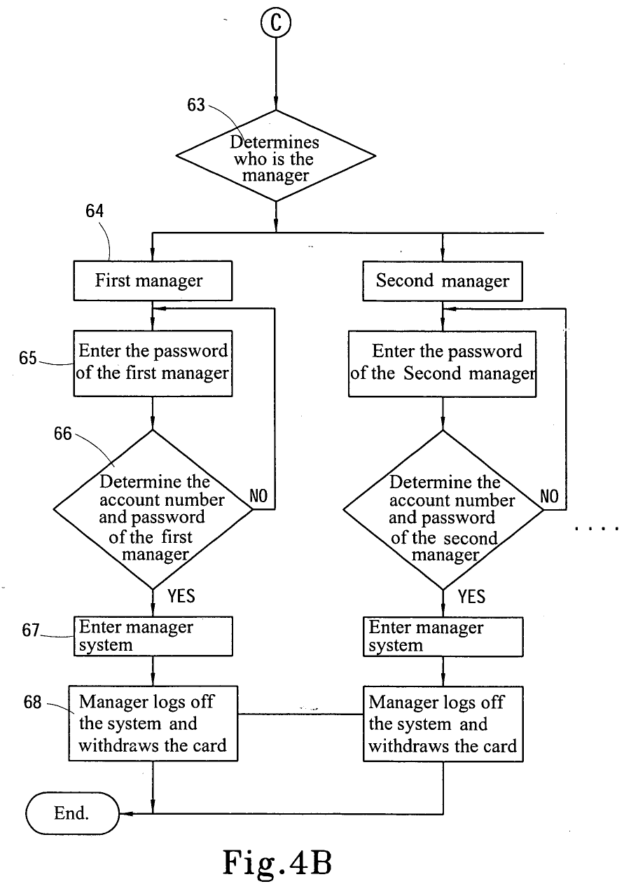

Refer to FIGS. 4A and 4B for the identification flow of the invention for logon the system by card. Manager or user start the logon system 6; insert card 61; determine whether the key word of the card is a manager or a user 62; for the manager card, the system determines who is the manager 63; if the first manager is identified, the account number of the first manager automatically appears 64; enter the password of the first manager 65; determine whether the account number and password of the first manager are correct 66; if not correct, the system returns to the state of input account number and password; if the input account number and password are correct, enter manager system 67. After use of the manager system is finished, the manager logs off the system and withdraws the card 68 to end the manager system. When the system determines the keyword 62 is a user card, determines who is the user 69; if a first user is identified, the account number of the first user automatically appears 60; enter the password of the first user 601; the system determines whether the account number and password of the first user are correct 602; if not correct, the system returns to the state of input account number and password; if the input account number and password are correct, enter user system 603. After use of the user system is finished, or use time expires, the user logs off the system and withdraws the card 604 to end the user system.

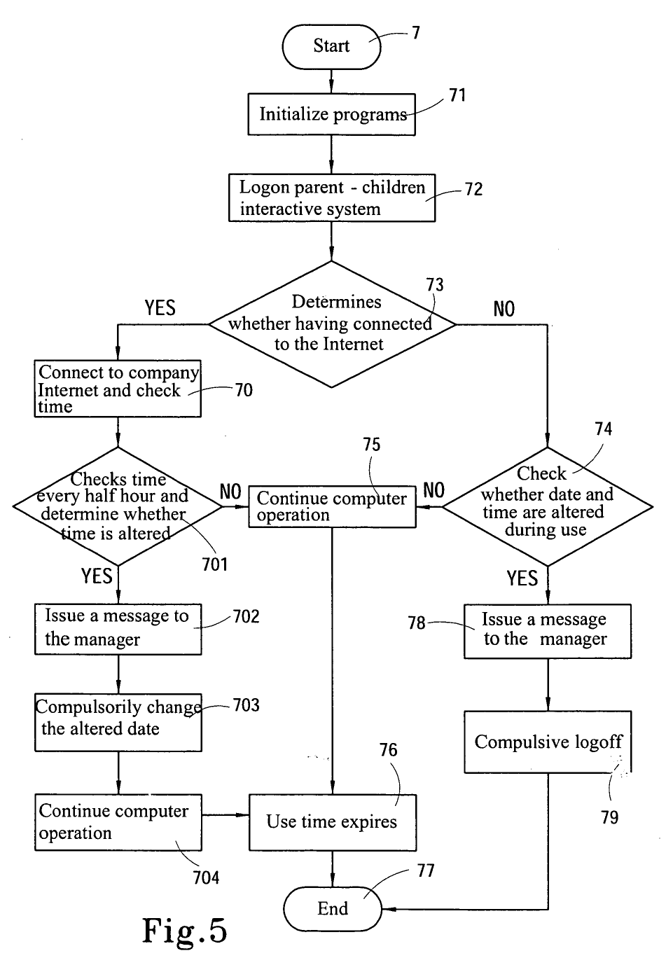

Refer to FIG. 5 for use time management flow for users of the invention. The general personal computer usually has time and date adjustment features for adjusting internal time and date of the computer. Based on the consideration that once the user changes the time and date in the computer, he/she can alter the data settings in the user card or manager card, hence time and date management does not display time on the computer used by the manager or user, instead, another server is used to control use time of users. User starts the system 7; initialize programs 71; logon parent-children interactive system 72; the system determines whether having connected to the Internet 73; if not, determine whether date and time are altered during use 74; if date is not altered, continue computer operation 75 until the setting time expires 76, and end system operation 77; if it is determined that date and time have been altered, issue a message to the manager 78, and a forced system logoff is executed 79, and end system operation. If the system determines that the Internet is connected, directly connect to the server (company Web site) to check time 70; the system checks time every half hour and determines whether time is altered 701; if time is not altered, continue computer operation 75 until the setting time expires 76, and end system operation 77; if it is determined that time has been altered, issue a message to the manager 702, and the altered date is compulsorily changed back 703; continue computer operation 704 until the setting time expires 76, and end system operation 77. The time management set forth above is managed by another server to prevent users to bypass the time restriction and enable the parent-children interactive management system to achieve management functions.

In addition, the parent-children interactive management system of the invention may also be adapted to ordinary companies and organizations to manage computer utilization. The system of the invention for users and managers may be changed to employees and executives to effectively manage computer utilization in the company and prevent data from being stolen or copied illegitimately.

While the preferred embodiments of the invention have been set forth for the purpose of disclosure, modifications of the disclosed embodiments of the invention as well as other embodiments thereof may occur to those skilled in the art. Accordingly, the appended claims are tended to cover all embodiments which do not depart from the spirit and scope of the invention.

1. A parent-children interactive intelligent management system for managing computer use authorization, time and operating system functions, comprising:
a computer device having operating systems loaded therein to manage and add the loaded parent-children interactive intelligent management system;
a reading device connecting to the computer device; and
a memory device insertable into the reading device;
wherein the computer device is empowered to perform settings of user authorization, time and use operating systems on data in the memory device after the memory device has been inserted into the reading device to facilitate managing computer device use conditions of users.

2. The parent-children interactive intelligent management system of claim 1, wherein the computer device is a desktop computer.

3. The parent-children interactive intelligent management system of claim 1, wherein the computer device is a notebook computer.

4. The parent-children interactive intelligent management system of claim 1, wherein the reading device is a card reader.

5. The parent-children interactive intelligent management system of claim 1, wherein the memory device is selectively an IC card or a diskette.

6. The parent-children interactive intelligent management system of claim 1, wherein after the system has been initialized and a manager card is inserted, the computer device displays a picture for entering manager password, the card is locked after the password has been mistakenly entered three times.

7. The parent-children interactive intelligent management system of claim 6, wherein the computer device automatically displays an account number for each insertion of the card.

8. The parent-children interactive intelligent management system of claim 6, wherein the system setting also is permitted to unlock the card after the password has been mistakenly entered three times.

9. The parent-children interactive intelligent management system of claim 1, wherein functions of the parent-children interactive intelligent management system include at least function setting, card setting, record inquiry, advanced setting and system descriptions.

10. A parent-children interactive intelligent management system for managing program execution system setting methods of computer internal systems, comprising:
a. during software installation software automatically add preset manager and user account numbers and passwords into a control station;
b. entering the parent-children intelligent management system when input password (with the account number shown automatically) is corrected, managers being permitted to execute functions of the parent-children intelligent management system; and
c. completing program execution system setting after the aforesaid functions have been executed;

11. A parent-children interactive intelligent management system including a method to alter card authorization setting, the method comprising:
a. inserting a card, entering passwords, and entering a manager system;
b. inserting a manager card into a reading device, processing alteration of data in the manager card and user cards, and settings of manager and user account numbers and passwords to complete setting of the manager card; and
c. inserting a user card, processing alteration of user card use authorization, and settings of use time period, use time for each insertion of the card each day, use time frame in one week and alert minutes prior to use time expiration.

12. A parent-children interactive intelligent management system including a method to manage identification for logging on system by cards, the method comprising:
a. inserting a card to determine a user or a manager by a keyword in the card before the manager or the user logs on;
b. determining the manager when a manager card is identified, entering a first manager account number and password when the first manager is determined, entering a manager system, completing use of the manager system, the manager logging off the system and withdrawing the card; and
c. determining a first user when a user card is identified by the system based on the keyword of the card, entering a first user account number and password, entering a user system, completing use of the user system, the user logging off the system when use time expires and withdrawing the user card.
